(19) United States
(12) Patent Application Publication
(10) Pub. No.: US 2016/0183131 A1
(43) Pub. Date: Jun. 23, 2016

(54) LTE Small Cell Handover To Carrier-Grade Wifi

(71) Applicant: Alcatel-Lucent USA Inc., Murray Hill, NJ (US)

(72) Inventors: Mohammad R. Khawer, Lake Hopatcong, NJ (US); Yigang Cai, Naperville, IL (US); Robert A. Soni, Randolph, NJ (US)

(73) Assignee: Alcatel-Lucent USA Inc., Murray Hill, NJ (US)

(21) Appl. No.: 14/576,405

(22) Filed: Dec. 19, 2014

(51) Int. Cl. H04W 36/00; H04W 36/24

(52) U.S. Cl. CPC H04W 36/0011; H04W 36/24

(57) ABSTRACT

Mobile units are handed over from LTE to carrier grade WiFi. The LTE can be licensed (LTE-L) or unlicensed (LTE-U). Charging mechanisms for co-located and integrated WiFi are also provided. When an LTE-U capable mobile unit moves into the LTE-U coverage area of a small cell, the mobile unit can use the unlicensed spectrum for a data session, thereby effectively increasing the data capacity of the network. When the mobile unit moves within the carrier grade Wi-Fi coverage area of the small cell, the small cell can handover the entire data session to the carrier grade Wi-Fi access point, thereby freeing up LTE system resources to provide data services to other mobile units.

### FIELD OF THE INVENTION

The present invention relates generally to communication systems.

### BACKGROUND OF THE INVENTION

The demand for mobile wireless data is growing at an exponential rate. Industry is preparing for what is being labeled as the 1000× data rate growth in the coming years. A several fold increase in spectrum is needed to meet such an increasing demand in mobile wireless data rate growth.

Spectrum for wireless communication is limited, however. In order to meet this increasing demand for data transmissions, new ways to transmit data in the unlicensed spectrum will need to be found.

One way to meet the increased demand for data is to utilize multiple carrier technologies utilizing both licensed and unlicensed spectrum. However, there can be problems with having multiple paths, including, for example, security and the handing off of data sessions between different technologies.

Therefore, a need exists for a way to utilize multiple carrier technologies while addressing security, handoff, and other multiple carrier technologies.

### BRIEF SUMMARY OF THE INVENTION

An exemplary embodiment of the present invention provides for small cell handover from LTE to carrier grade WiFi, which can be co-located or built into the small cell. The LTE can be licensed (LTE-L) or unlicensed (LTE-U). Charging mechanisms for co-located and integrated WiFi are also provided.

When an LTE-U capable mobile unit moves into the LTE-U coverage area of a small cell, the mobile unit can use the unlicensed spectrum for data session, thereby effectively increasing the data capacity of the network. When the mobile unit moves within the carrier grade Wi-Fi coverage area of the small cell, the small cell can handover the entire data session to the carrier grade Wi-Fi AP, thereby freeing up LTE system resources to provide data services to other mobile units. The use of the unlicensed spectrum provides an opportunity to the service provider to offer lower tariff data services using LTE-U and carrier-grade Wi-Fi while increasing the overall system capacity to handle more mobile subscribers. Similarly, when a mobile unit moves out of the carrier-grade WiFi coverage area of the small cell, the mobile unit can be handed over to the LTE-L/LTE-U service provided by the small cell. Appropriate tracking of data session over carrier grade WiFi, LTE-U or LTE using unique session identifier, multiple handover identifiers, and handover sequence numbers, will allow the service provider to introduce smart pricing options to their subscribers.

### BRIEF DESCRIPTION OF THE SEVERAL VIEWS OF THE DRAWINGS

FIG. 1 depicts the functional architecture of a communication network in accordance with an exemplary embodiment of the present invention.

FIG. 2 depicts a flow chart of small cell handover of a data session to carrier-grade WiFi in accordance with an exemplary embodiment of the present invention.

FIG. 3 depicts a flow chart of a charging mechanism in accordance with an exemplary embodiment of the present invention.

### DETAILED DESCRIPTION OF THE INVENTION

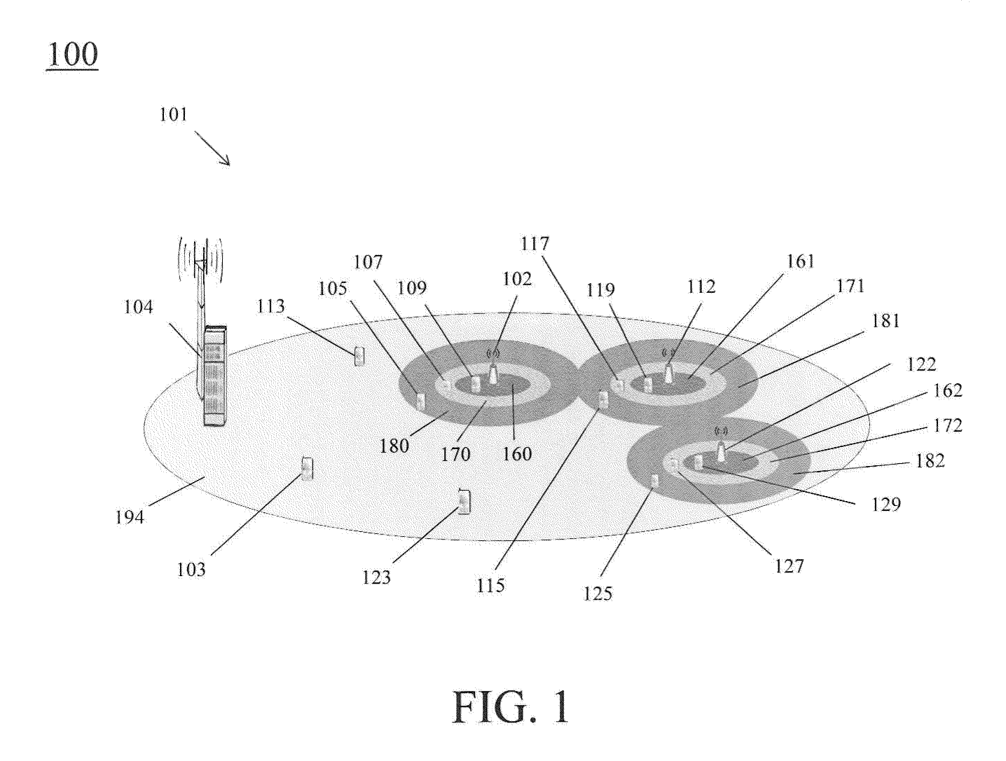

FIG. 1 depicts the functional architecture of a communication network 100 in accordance with an exemplary embodiment of the present invention. Communication network 100 preferably includes wireless network 101, macro Evolved Node B (eNodeB or eNB) 104, metro eNBs 102, 112, and 122, and mobile units 103, 105, 107, 109, 113, 115, 117, 119, 123, 125, 127, and 129. It should be understood that additional network elements can be included in communication network 100, but only these elements are depicted for clarity.

Wireless network 101 is a wireless communication network that provides subscribers the ability to place and receive calls to other communication units. Network 101 can utilize any wireless network protocol, including but not limited to 3G, WCDMA, CDMA2000, LTE and WiMAX.

In accordance with an exemplary embodiment, wireless network 101 authorizes carrier grade WiFi. Carrier grade WiFi can preferably belong to any third parties equipped with carrier grade functions. In accordance with an exemplary embodiment, wireless network 101 sets the priority of authorized WiFi which are in the vicinity of multiple small cells or macro cells.

In accordance with an exemplary embodiment, wireless network 101 provisions a list of authorized WiFi candidate cells into a handover candidate list. The cells can be small cells, macrocells, or both. The list can be static or dynamic. Small cells preferably know the coverage and transmit power strength of WiFi transmitters in the list. In LTE systems, small cells can shift data service to authorized WiFi for LTE service.

Macro eNB 104 provides radio coverage within a macrocell 194 using licensed spectrum. Macro eNB 104 is a wireless base station that communicates with mobile units within macrocell 194 and connects the mobile units to the land-line network for call completion.

Metro eNBs 102, 112, and 122 each comprise a small, low-power cellular base station. Metro eNBs can alternately be referred to as small cells.

In an exemplary embodiment, carrier grade WiFi is integrated within metro eNBs 102, 112, and 122. Alternately, carrier grade WiFi is standalone and co-located with metro eNBs 102, 112, and 122.

In accordance with the exemplary embodiment, each metro eNB 102, 112, and 122 includes three coverage areas: a carrier-grade WiFi coverage area, a metro LTE eNB unlicensed carrier coverage area, and a metro LTE eNB licensed carrier coverage area. In the exemplary embodiment depicted in FIG. 1, metro eNB 102 includes carrier-grade WiFi coverage area 160, metro LTE eNB unlicensed carrier coverage area 170, and metro LTE eNB licensed carrier coverage area 180. In the exemplary embodiment depicted in FIG. 1, metro eNB 112 includes carrier-grade WiFi coverage area 161, metro LTE eNB unlicensed carrier coverage area 171, and metro LTE eNB licensed carrier coverage area 181. In the exemplary embodiment depicted in FIG. 1, metro eNB 122 includes carrier-grade WiFi coverage area 162, metro LTE eNB unlicensed carrier coverage area 172, and metro LTE eNB licensed carrier coverage area 182.

In accordance with an exemplary embodiment, a new control interface is installed between carrier-grade WiFi and each metro eNB 102, 112, and 122 for control signaling sync up. The control interface can be, for example, an X2-Unlicensed Spectrum, or X2-U. The X2-U preferably allows the small cell handover of data service to the WiFi and back to the metro eNB. X2-U preferably passes charging data from the WiFi to the metro eNBs, which relay the charging data to a Serving Gateway (SGW) or Mobility Management Entity (MME).

Carrier grade WiFi preferably collects all charging related information for WiFi data sessions. A charging module is preferably built into the carrier grade WiFi to conduct the charging data collection function. This preferably includes time count, volume count, service types, data types, handover ID, sequence numbers, and charging correlation information.

Mobile units 103, 105, 107, 109, 113, 115, 117, 119, 123, 125, 127, and 129 each include an interface, a receiver, a transmitter, a processor, and memory. In the exemplary embodiment depicted in FIG. 1, mobile units 103, 113, and 123 are located in coverage area 194 and served by macro eNB 104. In the exemplary embodiment depicted in FIG. 1, mobile units 105, 115, and 125 are located in coverage areas 180, 181, and 182, respectively, and served by metro eNBs 102, 112, and 122, respectively. In the exemplary embodiment depicted in FIG. 1, mobile units 107, 117, and 127 are located in coverage areas 170, 171, and 172, respectively, and served by metro eNBs 102, 112, and 122, respectively. In the exemplary embodiment depicted in FIG. 1, mobile units 109, 119, and 129 are located in coverage areas 160, 161, and 162, respectively, and served by metro eNBs 102, 112, and 122, respectively.

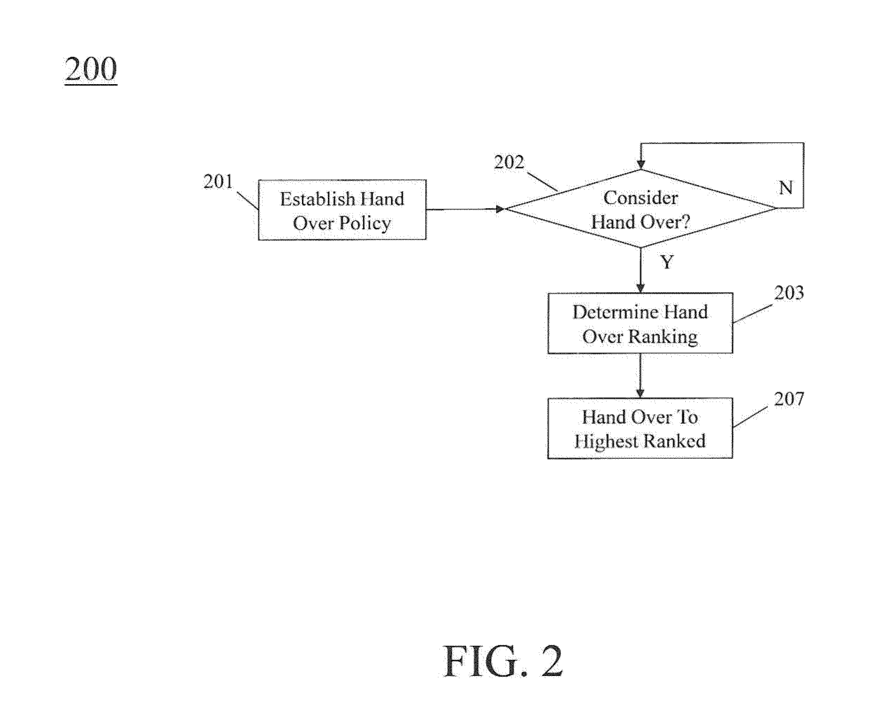

FIG. 2 depicts a flow chart 200 of small cell handover of a data session to carrier-grade WiFi in accordance with an exemplary embodiment of the present invention. Carrier grade WiFi access points (APs) commonly charge lower rates for wireless data usage. An exemplary embodiment determines whether offloading data usage to an available WiFi AP is more cost effective for a user than using the wireless service provider for data usage. If so, the data is handed over to the WiFi AP.

A policy engine establishes (201) policy steering rules and criteria for when to hand over data service for a mobile unit between an LTE data channel and a WiFi AP. The LTE data channel can be, for example, LTE-L or LTE-U. A metro eNB determines (202) whether a data session should be handed over, either from an LTE data session to a carrier-grade WiFi session or from a carrier-grade WiFi session to an LTE data session. In accordance with an exemplary embodiment, a metro eNB maintains control data of a data session on WiFi AP. In accordance with an exemplary embodiment, when any criteria change during a data session, the metro eNB can switch LTE data service from a WiFi AP back to LTE, whether LTE-L, LTE-U within small cell, or other WiFi. The metro eNB preferably uses static and dynamic rules in determining whether to hand over a data session and conducts all necessary radio measurements to maintain the performance and quality of data service when handing over to and from carrier grade WiFi APs.

In accordance with an exemplary embodiment, a metro eNB determines (203) a WiFi AP to handover the data service based on an evaluation of the hand over criteria. The policy engine selects a carrier-grade WiFi AP from a list to offload data flows to. The policy engine can be a network policy controller or alternately functionality incorporated into a small cell.

In accordance with an exemplary embodiment, the policy engine can use any or all of the following criteria to determine which is the preferred hand over WiFi AP. These criteria include, but are not limited to, carrier-Grade WiFi priority and weight, a smart pricing policy, incentive for using a WiFi, content service from WiFi, the signaling strength of a WiFi AP, traffic load of a WiFi AP, signal-to-noise level of WiFi AP, UE moving speed, security, energy efficiency based on proximity to the radio, and WiFi AP ownership.

Smart pricing policy comprises a policy to handover a mobile user's data usage to a WiFi AP when a tariff rate is lowest at that WiFi.

Incentive from using a WiFi comprises free or discounted access offered by stores, restaurants, or others to patrons of their businesses.

Content service from WiFi comprises advertisements, coupons or other incentives to customers located in or near their business.

UE moving speed is considered to avoid making frequent handovers.

Security comprises taking into account how important the security of the data exchange is. For example, there may be some data that a user does not want transported over a public WiFi AP, and so would not desire to move any such data traffic to a WiFi AP.

Once a WiFi AP has been selected, the data session is handed over to the selected WiFi AP. A metro eNB can also hand over a data service to multiple WiFi APs in sequence based on criteria within a data session. Each data session preferably includes a unique session identifier, multiple handover identifiers, and handover sequence numbers.

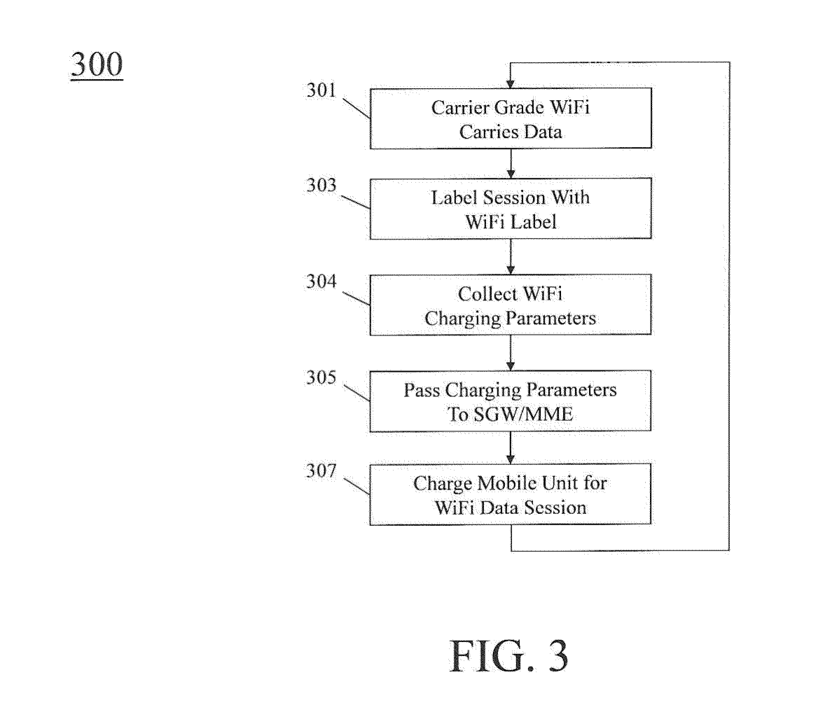

FIG. 3 depicts a flow chart 300 of a charging mechanism in accordance with an exemplary embodiment of the present invention.

In accordance with this exemplary embodiment, carrier-grade WiFi carries (301) wireless data that has been handed over from an LTE metro eNB.

In accordance with an exemplary embodiment, charging sessions are labeled (303) with a carrier-grade WiFi identifier.

The associated metro eNB preferably collects (304) WiFi charging parameters via an X2-U interface from a WiFi AP. In accordance with an exemplary embodiment, the metro eNB is responsible for interfacing with the wireless network for subscriber charging.

The LTE charging parameters with carrier-grade WiFi may include but are not limited to a carrier-grade WiFi identifier, a carrier-grade WiFi ownership type, a carrier-grade WiFi deployment mode, an LTE core network type, an LTE channel, an LTE band, a WiFi handover indicator, a charging ID, a handover ID, a handover sequence number, and a charging correlation ID. The carrier-grade WiFi deployment mode can be, for example, indoor, outdoor, standalone, or integrated within eNB.

In accordance with an exemplary embodiment, the metro eNB passes (305) the carrier-grade WiFi charging parameters to an SGW or MME. For a standalone WiFi AP, the metro eNB preferably indicates the handover destination and time spans, and each time span includes a unique sequence number.

The SGW or MME charges (307) the mobile unit for the WiFi data session. The charging can be either online or offline. The SGW or MME triggers the charging request with charging information from the metro eNB, preferably with WiFi charging data along with other charging sub-session data from the LTE-L or LTE-U session.

The SGW or MME preferably includes new LTE-U charging parameters in the charging request to an OCS (Online Charging System) or CDF (Charging Data Function). The OCS or CDF preferably rates Carrier Grade WiFi data usage accordingly with service provider configured LTE-U charging plans.

In an alternate exemplary embodiment, a standalone WiFi controller sends charging information via TCP/IP or other protocol to an authorized charging entity. That charging entity receives the charging information from the WiFi controller, and this preferably triggers a charging request. The OCS/CDF correlates charging requests from the SGW or MME and the WiFi charging entity with correlation charging ID, and determines the charging for the session.

While this invention has been described in terms of certain examples thereof, it is not intended that it be limited to the above description, but rather only to the extent set forth in the claims that follow.

We claim:

1. A method for handing over a mobile unit to carrier-grade WiFi comprising:
determining that a mobile unit should be handed over to a carrier-grade WiFi coverage area; and
handing over the mobile unit to use the carrier-grade WiFi for a data session.

2. A method for handing over a mobile unit in accordance with claim 1, the method further comprising handing over the mobile unit to a wireless coverage area when the mobile unit moves out of the carrier-grade WiFi coverage area.

3. A method for handing over a mobile unit in accordance with claim 1, the method further comprising the step of tracking the data session using session identifiers.

4. A method for handing over a mobile unit in accordance with claim 3, wherein one of the session identifiers comprises a handover sequence number.

5. A method for handing over a mobile unit in accordance with claim 3, wherein one of the session identifiers comprises a multiple handover identifier.

6. A method for handing over a mobile unit in accordance with claim 1, wherein the step of determining that a mobile unit should be handed over comprises determining that a mobile unit should be handed over based on an evaluation of hand over criteria.

7. A method for handing over a mobile unit in accordance with claim 6, wherein the hand over criteria comprises carrier-grade WiFi priority.

8. A method for handing over a mobile unit in accordance with claim 6, wherein the hand over criteria comprises carrier-grade WiFi weight.

9. A method for handing over a mobile unit in accordance with claim 6, wherein the hand over criteria comprises a policy to handover a mobile unit to the carrier-grade WiFi when a first tariff rate at the carrier-grade WiFi is lower than a second tariff rate at a metro eNodeB.

10. A method for handing over a mobile unit in accordance with claim 6, wherein the hand over criteria comprises an incentive for using a WiFi access point.

11. A method for handing over a mobile unit in accordance with claim 6, wherein the hand over criteria comprises content service from a WiFi access point.

12. A method for handing over a mobile unit in accordance with claim 6, wherein the hand over criteria comprises the signal strength of a WiFi access point.

13. A method for handing over a mobile unit in accordance with claim 6, wherein the hand over criteria comprises the traffic load of a WiFi access point.

14. A method for handing over a mobile unit in accordance with claim 6, wherein the hand over criteria comprises the signal-to-noise level of WiFi access point.

15. A method for handing over a mobile unit in accordance with claim 6, wherein the hand over criteria comprises security parameters.

16. A method for handing over a mobile unit in accordance with claim 6, wherein the hand over criteria comprises energy efficiency based on proximity to the WiFi access point.

17. A method for billing a mobile unit for data usage of a WiFi access point, the method comprising:
carrying wireless data in a data session for a mobile unit on a WiFi access point;
labeling the data session with a WiFi identifier;
collecting WiFi charging parameters including the WiFi identifier; and
sending the WiFi charging parameters to a charging processor.

18. A method for billing a mobile unit for data usage of a WiFi access point in accordance with claim 17, the method further comprising the step of, prior to carrying wireless data in a data session for a mobile unit on a WiFi access point, carrying the wireless data in a wireless data session.

19. A method for billing a mobile unit for data usage of a WiFi access point in accordance with claim 17, wherein the WiFi charging parameters include at least one of the following: a carrier-grade WiFi ownership type; a carrier-grade WiFi deployment mode; an LTE core network type; an LTE channel; an LTE band; a WiFi handover indicator; a charging ID; a handover ID: a handover sequence number; and a charging correlation ID.
